(19) United States
(12) Patent Application Publication
(10) Pub. No.: US 2008/0233402 A1
(43) Pub. Date: Sep. 25, 2008

(54) Carbon black with attached carbon nanotubes and method of manufacture

(75) Inventors: Thomas F. Carlson, Azle, TX (US); Heng-Huey H. Yang, Bedford, TX (US); Wesley A. Wampler, Weatherford, TX (US)

Correspondence Address: BRACEWELL & GIULIANI LLP, P.O. BOX 61389, HOUSTON, TX, 77208-1389, US

(73) Assignee: Sid Richardson Carbon & Gasoline Co.

(21) Appl. No.: 11/449,501

(22) Filed: Jun. 8, 2006

(51) Int. Cl. B32B 9/00; B32B 5/16

(52) U.S. Cl. 428/408; 428/323; 977/742

(57) ABSTRACT

A novel composition of matter comprises carbon black as a catalyst support for the growth of carbon nanotubes that directly adhere to the carbon black. When the composition of matter is mixed in plastic, oil, water, rubber, etc., the carbon nanotubes are carried as part of the carbon black aggregates and remain in intimate contact. A method of producing the composition of matter also is disclosed.

### BACKGROUND OF THE INVENTION

1. Technical Field

The present invention relates in general to carbon black and carbon nanotubes and, in particular, to a novel composition of matter comprising a substrate of carbon black having carbon nanotubes grown thereon, and a method of manufacturing the novel composition of matter.

2. Description of the Related Art

In the prior art, carbon black has been mixed with many different materials to improve the properties of end use applications. For example, carbon black is widely used as a rubber-reinforcing filler in tires and various industrial rubber products, as well as a colorant for printing inks, paints, coatings, etc. Since the surface of carbon black largely comprises graphitic crystallites, it has a certain inherent degree of electrical conductivity and thus is also used as a filler for the purpose of imparting electrostatic properties to plastics, paints, and other non-conductive materials. In order to gain acceptable electrical conductivity without high loadings (and higher stiffness), carbon black may be chemically oxidized such that only a hollow “shell” of the graphitic carbon black structure remains. This has the effect of significantly reducing the density of the carbon black, allowing equivalent conductivity with a lower carbon black/polymer ratio.

In another application, conductive carbon black has been mixed with carbon nanotubes (CNT) to form a cable compound with certain desirable properties. See U.S. Patent Application No. 2005/0064177 to Lee. Although the carbon black particles and the CNT remain discrete and separate in the solution, their intermingled presence does provide some advantages.

Similarly, Japanese Patent Application No. JP2001281964 to Shuichi, describes a brush having a mixture or dispersion of carbon black and CNT in a base resin. Although these solutions do have some advantages, the properties they provide are not isotropic as the carbon black and CNT are not attached directly to each other and therefore cannot form uniform structures in their respective mixtures.

Unfortunately, incorporating CNT into other materials is inhibited by the chemical nature of the CNT side walls. Problems such as phase separation, aggregation, poor dispersion within a matrix, and poor adhesion to the host inhibit their adoption as a quality additive. One solution to these problems is to use surface treatments that exfoliate, disperse, and improve the interaction between CNT and the host matrix.

CNT also may be formed and grown on both supported and unsupported catalyst particles. See, e.g., U.S. Pat. No. 6,333,016 to Resasco, and U.S. Patent Application No. 2005/0029498 to Elkovitch. However, in those procedures the CNT are separated from the catalyst particles (i.e., harvested) for use in other applications.

In still other applications, hybrid materials such as silica and carbon black have been formed for lower hysteresis in rubber that is characteristic of silica fillers. See, e.g., U.S. Pat. Nos. 5,159,009; 5,877,238; 5,904,762; 5,977,238; 6,057,387; and 6,364,944. For example, these materials are typically formed by injecting organosilane materials into a carbon black furnace during soot formation. Although these prior art designs are workable for enhancing the performance of some materials, an improved solution for expanding other applications would be desirable.

### SUMMARY OF THE INVENTION

One embodiment of a novel composition of matter incorporates carbon black as a substrate for the purpose of growing carbon nanotubes (CNT) that are adhered to the support. A method of producing the composition of matter is also disclosed. The present invention is not merely another route to preparing single wall (SW) CNT or multi-wall (MW) CNT, but a means of deliberately creating a unique material that is a hybrid of carbon black and CNT. Properties of this hybrid may be tailored for specific applications, depending on the grade of carbon black used and also whether SWCNT or MWCNT are grown.

When the composition of matter of the present invention is mixed in plastic, oil, water, rubber, etc., the CNT are carried along as part of the carbon black aggregates and remain in intimate contact. This is different than merely mixing carbon black as a separate ingredient with CNT. Studies in dispersion mechanics clearly show that the dispersion of two particulate ingredients is never as homogeneous as when one species is directly bound to the other. Because of the synergistic effect, the resulting properties of a filled plastic or rubber article are vastly different from a similar article obtained by mixing the two ingredients separately.

The foregoing and other objects and advantages of the present invention will be apparent to those skilled in the art, in view of the following detailed description of the present invention, taken in conjunction with the appended claims and the accompanying drawings.

### BRIEF DESCRIPTION OF THE DRAWINGS

So that the manner in which the features and advantages of the present invention, which will become apparent, are attained and can be understood in more detail, more particular description of the invention briefly summarized above may be had by reference to the embodiments thereof that are illustrated in the appended drawings which form a part of this specification. It is to be noted, however, that the drawings illustrate only some embodiments of the invention and therefore are not to be considered limiting of its scope as the invention may admit to other equally effective embodiments.

FIG. 1 is a magnified TEM image of a composition of matter constructed in accordance with the present invention;

FIG. 2 is a magnified SEM image of a composition of matter constructed in accordance with the present invention; and

FIG. 3 is a high level flow diagram of one embodiment of a method constructed in accordance with the present invention.

### DETAILED DESCRIPTION OF THE INVENTION

“Particle,” as used in this disclosure, is also referred to by those familiar with the art as “primary particles,” and means individual, generally spherical units, formed at the early stages of the carbon black synthesis process, which cannot be subdivided by ordinary means. Further, the term “aggregate,” as used herein, refers to an accumulation of these particles that are fused together and tightly bonded. Aggregates generally cannot be broken down into individual particles through mechanical means, particularly when aggregates are being combined with other materials in a mixing operation. The term “agglomerate” refers to an accumulation of aggregates that are generally held together by weaker physical (e.g., Van der Waals) forces and which can be separated by mechanical means, such as during a mixing operation.

In general, carbon black is prepared by a process that comprises completely burning a fuel, such as a low-boiling hydrocarbon oil or natural gas, to form a high temperature combustion gas stream, and then introducing a hydrocarbon feedstock into the high temperature combustion gas stream. A rapid thermal decomposition reaction occurs, leading to the formation of spheroidal primary particles through a complicated polycondensation reaction. These particles do not exist as discrete entities, but become partially fused, forming branched aggregates, similar to a cluster of grapes (aciniform morphology.) This process may be more thoroughly explained with respect to the mechanism of formation of carbon black, whereby carbon black is formed by the following steps.

In the furnace production process, the hydrocarbon feedstock is typically a No. 6 fuel oil containing numerous polyaromatic hydrocarbon species, primarily composed of carbon and hydrogen, along with some sulfur and traces of nitrogen and oxygen. The carbon content is usually on the order of 88-95% by weight, making the feedstock very viscous, and so the oil is generally heated in order to be sprayed into the hot combustion gases (atomization). The high furnace temperature (˜2800° F.) causes hydrogen atoms to split off of the aromatic species, leading to a reducing atmosphere just downstream of the feedstock injection position.

The formation process of carbon black is generally believed to occur in two stages: (i) the immediate formation of nuclei in the initial stage of the reaction, and (ii) the subsequent growth of particles as the reaction proceeds. For example, polyacetylene, polycyclic aromatic compounds, and other active hydrocarbons are formed at a very early stage of the thermal decomposition reaction. These compounds then undergo a radical reaction to form carbon black nuclei. In this stage, oxygen in the system is sufficiently supplied, and the reaction takes place as a result of high thermal energy accompanied by partial combustion of the starting material.

The carbon gasses remaining in the system after formation of the nuclear particles are then deposited on the surface of the carbon black nuclei, building up as combination of amorphous carbon and graphitic turbostratic crystallites. These reactions take place in a matter of nanoseconds. This energy level is lower than that of the nuclear particle formation zone and will continue in a non-oxidizing atmosphere after formation of carbon black particles. The fundamental particles and aggregates of final carbon black are formed depending upon the residence time, leading to the cessation of the formation reaction by water cooling downstream. A structure control additive, such as KCl, may be used to limit the degree of aggregation. Particle size is typically controlled by oil lance position and oil spray rate.

The carbon black formed by this process is in the form of loose soot with low density (10-60 kg/m³), depending on the grade and extent of particle size and aggregate branching. The loose black is filtered, densified in a surge tank, and conveyed to a pelletizer, where the addition of water and possibly a binder rolls the black into small spheres. These are dried and conveyed to storage tanks for shipment. The densified carbon black pellets (250-650 kg/m³) are generally preferred as they facilitate ease of handling and processing by consumers, although carbon black also may be sold in its loose state, depending on the user's application.

The carbon blacks used in the present invention can include but are not limited to the commonly available carbon blacks used in commercial applications, such as those designated by ASTM D-1765, as well as various channel blacks, and conductive carbon blacks. Other carbon blacks which may be utilized include non-ASTM furnace grades, acetylene blacks, thermal blacks, carbon/silica hybrid blacks, and blacks previously modified by chemical or thermal means, such as oxidized blacks and plasma-treated blacks. In addition, a mixture of two or more of the above blacks may be used in preparing the carbon black products of the invention.

The surface area of usable carbon blacks typically ranges from about 5 m²/g to 1200 m²/g or more, with structures ranging from about 5 mL/100 g or less, to about 400 mL/100 g or more. The use of a specific carbon black will vary as to the desired physical properties of the end product, such as rubber compounds. The determination of carbon black surface area and structure according to ASTM procedures are well known to those skilled in the art.

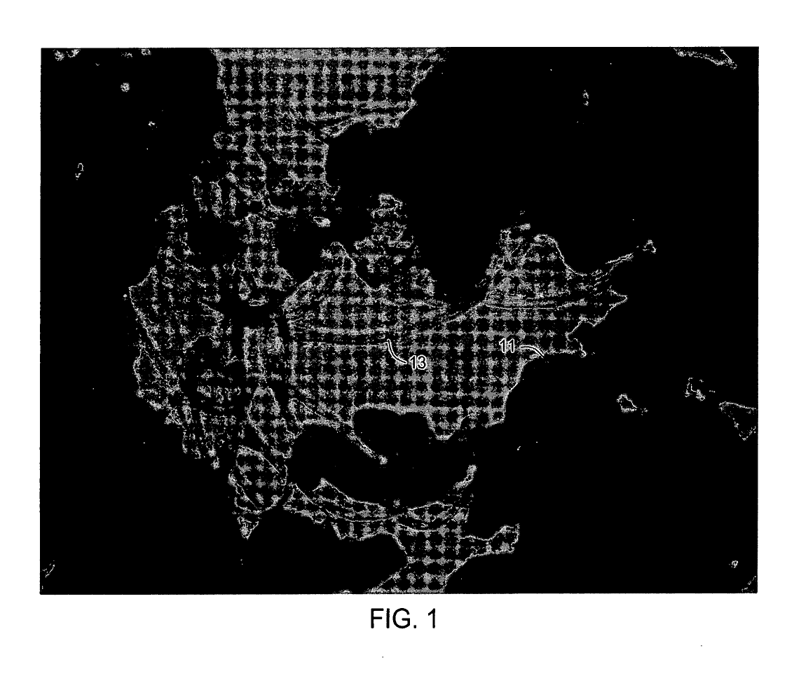

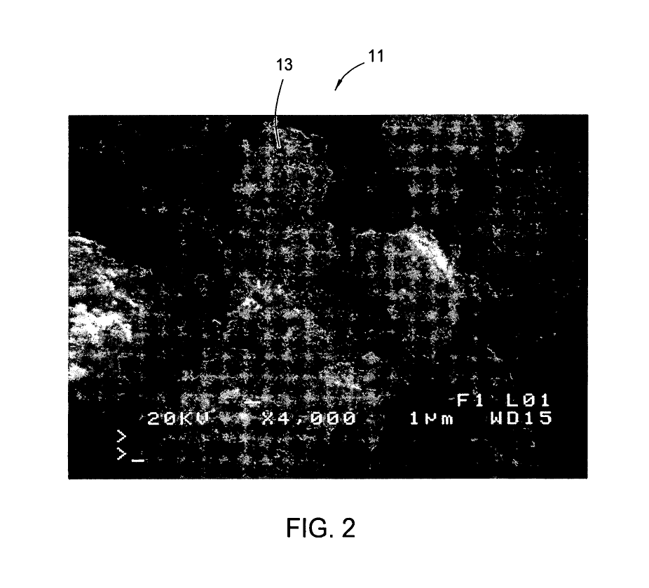

In one embodiment, the present invention comprises a novel composition of matter and method of producing it that incorporates carbon black as a catalyst support or substrate for the purpose of growing carbon nanotubes (CNT) on the carbon black. The composition of matter comprises carbon black particles 11 (FIGS. 1 and 2), each having an outer surface; and CNT 13 formed directly on and extending from the outer surfaces of the carbon black particles such that the carbon black particles form substrates that carry the CNT.

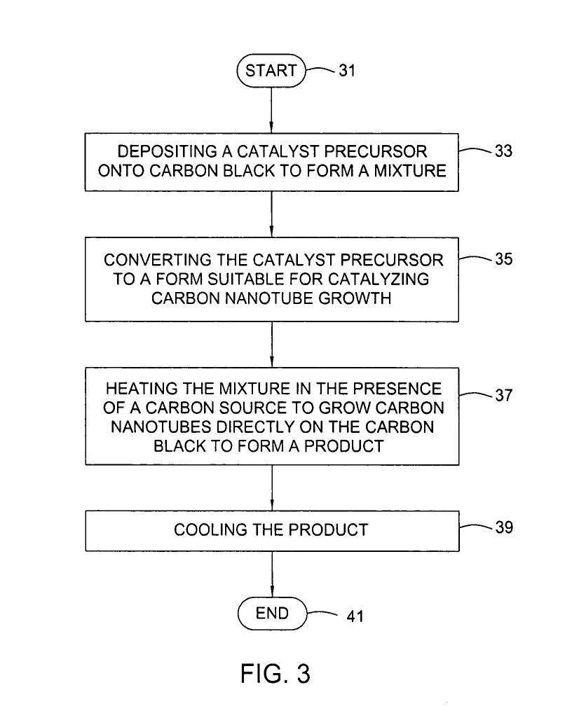

The present invention also comprises a method of manufacturing the novel composition of matter. In one embodiment (FIG. 3), the method begins as indicated at step 31, and comprises depositing a catalyst precursor onto carbon black existing, for example, in one of the forms described above (step 33); converting the precursor to a form suitable for catalyzing carbon nanotube growth (step 35; e.g., to a zero valent state); heating the carbon black-catalyst mixture in the presence of a carbon source to grow carbon nanotubes directly on the carbon black to form the product (step 37); and then cooling the product (step 39), before ending as indicated at step 41.

Initially, the method may comprise mixing a catalyst precursor composed of metal or metal oxide particles, a metal salt, or an organometallic compound (e.g., about 5% by weight of iron chloride) and carbon black. For example, the catalyst precursor and carbon black may be suspended in water or another suitable solvent and, after mixing, filtered and dried. The total amount of metallic catalyst deposited on the carbon black may vary widely, but is generally in an amount of about 0.1% to about 20% of the weight of the carbon black support, and more preferably from about 1% to about 10% by weight. The catalyst precursor is preferentially adsorbed or chemically bonded to the surface of the carbon black.

As described herein, the catalyst metal or precursor may include any metal particle, salt, or organometallic complex suitable for the growth of SWCNT or MWCNT, generally encompassing Groups 4-14 metals (new IUPAC nomenclature). Examples include, but are not limited to, the Group 6 metals, such as Cr, Mo, or W, Groups 8-10, e.g., Fe, Co, Ni and their congeners, Groups 11-14, or combinations thereof. Bimetallic catalysts composed of a combination of Group 6 and Group 8-10 metals are particularly effective at preferentially growing SWCNT.

In a subsequent step, the adsorbed or bonded catalyst metal precursor may be chemically reduced to a zero-valent state through the use of any effective reducing agent known to those familiar in the art. Examples may include, but are not limited to, Na₂S₂O₄, NaH, CaH₂, LiAlH₄, BH₃, NaBH₄, and the like. The reducing agent may be added directly to the carbon black-metal precursor slurry, or alternatively, the carbon black-catalyst metal precursor mix may first be filtered and dried prior to reduction.

In another embodiment, the dried carbon black-catalyst metal precursor may be contained in a chamber capable of being heated to some appropriate temperature and the metal reduced by bringing the mixture in contact with hydrogen gas for a sufficient period of time.

In another embodiment, the method may further comprise calcining the catalyst (e.g., in air or another suitable gas) at an elevated temperature (e.g., 300° C.-1200° C.) after the catalyst precursor mixing step but before the reduction step for a sufficient length of time (e.g., one hour) in order to form a metal oxide on the carbon black surface. The subsequent reduction step may be accomplished by again heating the carbon black-metal oxide mixture at an elevated temperature (e.g., 300° C.-1200° C.) and at, for example, ambient or higher pressure in a hydrogen gas or hydrogen-containing gas mixture for a sufficient length of time to reduce the metal oxide to a zero-valent metal. Alternatively, the carbon black-metal oxide material may be used directly in order to grow CNT on the surface of the carbon black.

In another alternate embodiment, the catalyst metal precursor may be added directly to a carbon black reactor during carbon black formation and become adsorbed, chemically bonded, or otherwise incorporated in the resulting carbon black. The metal may be directly reduced in the reactor by a combination of the high reactor temperature and enriched hydrogen gas environment resulting from the rapid thermal decomposition of the hydrocarbon starting material during carbon black formation. Additional hydrogen gas could be added to the reactor, if necessary, in order to achieve adequate metal reduction.

In yet another embodiment, the carbon black may first be treated with a plasma gas to clean the surface and add various functional groups. Examples of plasmas useful for this purpose include but are not limited to air, oxygen, nitrogen, ammonia, hydrogen, halogens, carbon disulfide, sulfur dioxide, nitric/nitrous oxide, etc. For example, the adsorption and distribution of iron chloride is apparently enhanced by pretreatment with air plasma, possibly due to the metal's affinity for oxygen.

The carbon black containing the zero-valent catalyst is exposed to a carbon-containing gas at elevated temperature for a sufficient period of time to achieve CNT growth on the surface. Examples of suitable carbon-containing gases include aliphatic hydrocarbons, both saturated and unsaturated, such as methane, ethane, propane, butane, hexane, ethylene and propylene; carbon monoxide; oxygenated hydrocarbons such as acetone, acetylene and methanol; aromatic hydrocarbons such as toluene, benzene and naphthalene; and mixtures of the above, for example carbon monoxide and methane. Use of acetylene promotes formation of multi-wall carbon nanotubes, while CO and methane are preferred feed gases for formation of single-wall carbon nanotubes. The carbon-containing gas may optionally be mixed with a diluent gas, such as hydrogen, helium, nitrogen, or argon.

The method of exposing the carbon black containing the active metal catalyst to the carbon-containing gas may include any such means necessary to ensure acceptable contact between the gas and substrate. In one embodiment, carbon black/catalyst is loaded into a container, such as a quartz boat, and exposed to a stream of gas flowing over the top at elevated temperature (e.g., 400° C. to 1200° C.). In another embodiment, the carbon black/catalyst is packed into a fluidized bed reactor, and the gas is passed through the bulk of the material at elevated temperature. In yet another embodiment, the catalyst may be added to the black during carbon black formation in a reactor and the carbon-containing gas introduced at a point downstream to allow in-situ growth of CNT on carbon black during typical carbon black production. The choice of reactor design, settings, and residence time needed to accomplish in-situ growth during carbon black production will be apparent to those skilled in the art.

The temperature and time required for sufficient CNT growth may vary, depending on the grade of carbon black chosen for the support, the type and quantity of CNT desired, and the selection of metal catalyst required to produce the desired CNT. Typically, a temperature range between about 400° C. and 1200° C. is sufficient for adequate CNT growth without thermal degradation of the carbon black support. Depending on the rate and desired extent of CNT formation, the time required may be as short as several seconds up to about one hour or longer. In general, longer exposure times of the carbon black/catalyst to the carbon-containing gas yield longer CNT or conversely, denser CNT coverage on the surface of the black (FIGS. 1 & 2).

The finished carbon black/CNT hybrid is preferentially cooled under a stream of argon gas, or a mixture hydrogen, helium, nitrogen, and/or argon. As an alternative, an oxidizing gas, such as oxygen, may also be added for the purpose of cleaning the surface of the product by combustion of amorphous carbon residue from the carbon black substrate or CNT attached thereon.

Finally, the carbon black/CNT hybrid material thus produced may be further post-treated by exposure to chemicals, gases, or plasmas for the purpose of further cleaning the surface or adding one or a number of functional groups or metal catalysts (e.g., platinum) thereon. The method of post-treatment may vary according to manufacturing techniques, but should be readily apparent to those skilled in the art.

While the present invention has been shown or described in only some of its forms, it should be apparent to those skilled in the art that it is not so limited, but is susceptible to various changes without departing from the scope of the invention.

What is claimed is:

1. A composition of matter, comprising:
carbon black, each having an outer surface; and
carbon nanotubes formed on and extending from the outer surfaces of the carbon black such that the carbon black is a substrate that carries the carbon nanotubes.

2. A composition of matter according to claim 1, wherein the carbon black has a surface area in a range of about 5 m²/g to 1200 m²/g.

3. A composition of matter according to claim 1, wherein the carbon black has a structure in a range of about 5 mL/100 g to 400 mL/100 g.

4. A method of manufacture, comprising:
(a) depositing a catalyst precursor onto carbon black to form a mixture;
(b) converting the catalyst precursor to a form suitable for catalyzing carbon nanotube growth;
(c) heating the mixture in the presence of a carbon source to grow carbon nanotubes directly on the carbon black to form a product; and then
(d) cooling the product.

5. A method according to claim 4, wherein step (b) comprises converting the catalyst precursor to a zero valent state.

6. A method according to claim 4, wherein step (a) further comprises selecting the catalyst precursor from the group consisting of a metal particle, a metal salt, and an organometallic complex, and step (b) comprises heating the mixture.

7. A method according to claim 6, wherein step (a) comprises mixing about 5% by weight of iron chloride and the carbon black.

8. A method according to claim 4, wherein the mixture of step (a) comprises limiting the catalyst precursor to a range of concentration of about 0.1% to 20% by weight of the carbon black.

9. A method according to claim 4, wherein the mixture of step (a) comprises limiting the catalyst precursor to a range of concentration of about 1% to 10% by weight of the carbon black.

10. A method according to claim 4, wherein step (a) comprises suspending the catalyst precursor and carbon black in a solvent and, after mixing, filtering and drying the mixture prior to step (b).

11. A method according to claim 4, wherein step (a) is selected from the group consisting of adsorbing and chemically bonding the catalyst precursor to a surface of the carbon black.

12. A method according to claim 4, further comprising, prior to step (c), heating the catalyst precursor and carbon black for sufficient time to form an oxide on the carbon black.

13. A method according to claim 4, further comprising, prior to step (a), or after step (d), treating the carbon black with a plasma gas or a chemical reactant to clean or modify the surface thereof and/or adding at least one functional group or metal.

14. A method according to claim 4, wherein step (a) comprises adding the catalyst precursor directly to a carbon black reactor during carbon black formation such that the catalyst precursor is directly incorporated into the carbon black.

15. A method according to claim 14, wherein step (b) comprises reducing the mixture in the carbon black reactor with a combination of a high reactor temperature and an enriched hydrogen gas environment resulting from a rapid thermal decomposition of a hydrocarbon starting material during carbon black formation with or without further hydrogen gas enrichment; and step (c) comprises introducing a carbonaceous gas downstream to allow in-situ growth of carbon nanotubes on the carbon black.

16. A method according to claim 4, wherein step (b) comprises chemical vapor deposition and heating the mixture at an elevated temperature and at a suitable pressure in a hydrogen environment for a suitable time, such as about 1 hour.

17. A method according to claim 4, further comprising calcining the catalyst precursor in air, or another suitable gas after step (a) and before step (c); and wherein the carbon source of step (c) comprises a carbonaceous gas.

18. A method according to claim 17, wherein step (c) comprises a method selected from the group consisting of (1) loading the chemically-reduced mixture into a container and exposing the chemically-reduced mixture to a stream of the carbonaceous gas flowing over a top thereof at elevated temperature; and (2) packing the chemically-reduced mixture into a fluidized bed reactor and passing the carbonaceous gas through a bulk of the chemically-reduced mixture at elevated temperature.

19. A method according to claim 4, wherein steps (a)-(d) comprise adding the catalyst precursor to the carbon black during carbon black formation in a reactor and introducing the carbonaceous gas downstream for in-situ growth of carbon nanotubes on the carbon black during production of the carbon black, and then cooling the product in the gases present during carbon black production.

20. A method according to claim 4, wherein step (d) comprises cooling in an inert gas environment.

21. A method according to claim 4, wherein step (d) occurs in an environment selected from the group consisting of hydrogen, helium, nitrogen, argon and an oxidizing gas.

22. A method according to claim 4, wherein the final carbon black/CNT material is further post-treated by chemical or plasma means.
